(19) United States
(12) Patent Application Publication
(10) Pub. No.: US 2012/0151746 A1
(43) Pub. Date: Jun. 21, 2012

(54) Apparatuses, Systems and Methods for the Attachment of Substrates to Supports with Light Curable Adhesives

(75) Inventors: John Mundaden, Pleasanton, CA (US); Chi Sou Yu, Saratoga, CA (US); Michael P. Mittmann, Palo Alto, CA (US)

(73) Assignee: AFFYMETRIX, INC., Santa Clara, CA (US)

(21) Appl. No.: 13/329,170

(22) Filed: Dec. 16, 2011

Related U.S. Application Data
(60) Provisional application No. 61/423,687, filed on Dec. 16, 2010.

(51) Int. Cl. B23P 17/04

(52) U.S. Cl. 29/527.1; 29/281.1

(57) ABSTRACT

Disclosed are apparatuses, systems and methods for attachment of substrates to supports. Disclosed are integrated pick-and-place curing apparatuses and systems and methods for using them. Integration of pick-and-place and curing functionalities provides higher efficiency and effectiveness compared to approaches which separate the two functions. Also disclosed are systems and methods for simultaneous attachment of a plurality of substrates to a support. Substrates include, within certain embodiments, arrays of biological polymers which are unaffected by the disclosed pick-and-place curing approaches.

### RELATED APPLICATIONS

This application claims priority to U.S. Provisional Patent Application No. 61/423,687, filed Dec. 16, 2010, which is incorporated herein by reference in its entirety for all purposes.

### FIELD OF THE INVENTION

Disclosed herein are apparatuses, systems and methods for the attachment of substrates to solid supports. Certain embodiments are related to the manufacturing and packaging of biological sensor devices, such as arrays of biological polymers positioned on solid substrates.

### BACKGROUND OF THE INVENTION

A variety of applications require the precise attachment of a substrate to a support through the use of an adhesive and a pick-and-place instrument. The use of light curable adhesives is popular within many applications, but requires the use of a suitable light source with which to cure the adhesive at issue. Thus, in many applications, especially those in which it is necessary to hold the substrate in place until curing is complete, the use of light curable adhesives added positional difficulties for the effective and efficient curing of the adhesive while the pick-and-place apparatus was still in contact with the substrate. Therefore, previous approaches, such as those disclosed within U.S. Patent Application Publication No. 2006/0088863, employ a plurality of light sources to cure the adhesives from multiple angles, and often employ two or more periods of illumination to ensure sufficient curing of the adhesive. There remains a need for apparatuses, and systems and methods for their use, in which the pick-and-place apparatus additionally cures the adhesive in a manner facilitating a single illumination period that is more efficient and effective than prior approaches. Furthermore, there is also a need for the precise curing and attachment of a plurality of substrates to a plurality of supports that is performed simultaneously to improve manufacturing efficiency, effectiveness and consistency.

### SUMMARY OF THE INVENTION

Disclosed herein are apparatuses, systems and methods for attachment of substrates to supports, either individually or through the simultaneous attachment of a plurality of substrates to a plurality of supports. Certain embodiments employ an apparatus which integrates pick-and-place curing through the use of vacuum to pick, hold and place the substrate with one or more light sources to subsequently cure the light curable adhesive and thus attach the substrate to the support. The vacuum is removed from the substrate after attachment to the support. Integration of the light source within the pick-and-place apparatus increases the effectiveness and efficiency of the attachment process by facilitating one step curing approaches which are substantially uniform for the substantial entirety of the adhesive at issue.

Certain embodiments employ apparatuses incorporating heat sinks and/or insulation components to dissipate heat generation by the relevant light source utilized to cure the adhesive. Such aspects serve to increase the effective life cycle of the apparatus, especially within embodiments designed to utilize higher illumination intensities and/or prolonged illumination periods. With some embodiments, the one or more light sources are light-emitting diodes.

Certain embodiments employ structural features on the substrate and/or support to prevent sensitive areas of the substrate from coming into contact with the apparatus. Sensitive areas may include, but are not limited to, arrays of biological polymers for those substrates which contain such arrays. Structural features on the substrate are also employed within certain embodiments for the purposes of verifying that the substrate was picked by the apparatus in an acceptable rotation, and if not, rotating the apparatus to compensate and thus ensure that the substrate is attached to the support within a desired rotation.

Also disclosed herein are embodiments with apparatuses, systems and methods for the simultaneous attachment of a plurality of substrates to a plurality of supports. Many such embodiments utilize a vacuum table to secure a plurality of groups of substrates in desired positions before simultaneously attaching a group of substrates to a secondary support, with the secondary support containing a plurality of supports with which the substrates are attached. The process of attachment is then repeated until all groups of substrates held by the vacuum table are appropriately attached to the supports of a secondary support. Some of these embodiments also utilize light curable adhesives. Many of these embodiments are capable of not only accelerating the manufacturing process but also increasing consistency and quality.

### BRIEF DESCRIPTION OF THE DRAWINGS

The accompanying drawings, which are incorporated in and form a part of this specification, illustrate embodiments of the invention and, together with the description, serve to explain various aspects of the invention.

FIG. 1(A) illustrates non-limiting examples of substrates 110 attached to supports 120.

FIGS. 1(B)-1(D) illustrate non-limiting examples of secondary supports 130, each possessing a plurality of supports 120.

FIGS. 2(A)-2(D) illustrate non-limiting examples of tertiary supports 210, each with a plurality of secondary supports 120, and with each secondary support 120 possessing a plurality of supports 110.

FIG. 3(A) illustrates a non-limiting example of a pick-and-place curing apparatus 300.

FIGS. 3(B)-3(C) illustrate a non-limiting example of a substrate contact component 360 which includes structural features 370.

FIGS. 4(A)-4(B) illustrate another non-limiting example of a pick-and-place curing apparatus 300.

FIGS. 5(A)-5(C) illustrate another non-limiting example of a pick-and-place curing apparatus 300.

FIGS. 6(A)-6(C) illustrate another non-limiting example of a pick-and-place curing apparatus 300.

FIGS. 7(A)-7(B) illustrate a non-limiting depiction of potential rotations of substrate 110 after initial picking by apparatus 300, as would be detected by a vision system.

FIG. 8(A) illustrates a non-limiting depiction of a wafer 810 while FIG. 8(B) illustrates a non-limiting example of a diced wafer 810 with substrates 820.

FIG. 8(C) illustrates a non-limiting depiction of a vacuum table 830 from above while FIG. 8(D) illustrates a non-limiting depiction of a diced wafer 810 placed on top of vacuum table 830.

FIGS. 8(E)-8(F) illustrate a non-limiting depiction of a plurality of supports 840 on a secondary support 850 which is intended for use with wafer 810 and vacuum table 830 as depicted within FIGS. 8(A)-8(D).

FIG. 8(G) illustrates a non-limiting depiction of the subdivision of substrates 820 within wafer 810 for use with four secondary supports 850 as depicted within FIGS. 8(E)-8(F).

FIG. 8(H) illustrates a non-limiting depiction of the interaction between diced wafer 810, vacuum table 830 and secondary support 850 for the attachment of substrates 820 to supports 840.

FIG. 9 contains a graph of life cycle testing results performed utilizing a plurality of different illumination intensities and durations with respect to the resulting effect on adhesive bond strength.

### DETAILED DESCRIPTION

The present invention has a variety of embodiments and relies on many patents, patent applications and other references for details known to those of ordinary skill in the art to which the invention pertains. Therefore, when a reference, such as a patent, patent application, and other publication is cited or otherwise mentioned herein, it should be understood that the reference is incorporated by reference in its entirety for all purposes as well as for the proposition that is recited.

The practice of certain embodiments may employ, unless otherwise indicated, conventional techniques and descriptions of organic chemistry, polymer technology, molecular biology (including recombinant techniques), cell biology, biochemistry, and immunology, which are within the skill of the art. Such conventional techniques may include polymer array synthesis, hybridization, ligation, and detection of hybridization using a label. Specific illustrations of suitable techniques can be had by reference to the embodiments described herein. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, Biochemistry, 4^{th} Ed., W.H. Freeman & Company (1995), Gait, “Oligonucleotide Synthesis: A Practical Approach,” IRL Press, London (1984), Nelson and Cox, Lehninger, Principles of Biochemistry 3^{rd} Ed., W.H. Freeman Pub., New York, N.Y. (2000), and Berg et al., Biochemistry, 5^{th} Ed., W.H. Freeman Pub., New York, N.Y. (2002), all of which are herein expressly incorporated by reference in their entirety for all purposes.

The practice of certain embodiments may also employ conventional software methods and systems. Computer software products utilized with embodiments of the present invention generally include computer readable medium having computer-executable instructions for performing various steps directly or indirectly associated with aspects of the present invention. Suitable computer readable medium include floppy disk, CD-ROM/DVD/DVD-ROM, hard-disk drive (e.g., utilized locally and/or over a network), flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods, PWS Publishing Company, Boston (1997), Salzberg, Searles, Kasif, (Ed.), Computational Methods in Molecular Biology, Elsevier, Amsterdam (1998), Rashidi and Buehler, Bioinformatics Basics: Application in Biological Science and Medicine, CRC Press, London (2000) and Ouelette and Bzevanis Bioinformatics: A Practical Guide for Analysis of Gene and Proteins, Wiley & Sons, Inc., 2^{nd} ed. (2001).

Throughout this disclosure, various aspects of the invention may be presented in a range format. It should be understood that when a description is provided in range format, this is merely for convenience and brevity, and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 2, from 1 to 2.5, from 1 to 3, from 1 to 3.5, from 1 to 4, from 1 to 4.5, from 1 to 5, from 1 to 5.5, from 2 to 4, from 2 to 6, and from 3 to 6 for example, as well as individual numbers within that range, for example, 1, 1.5, 2, 2.5, 3, 3.5, 4, 4.5, 5, 5.5, and 6. This applies regardless of the breadth of the range.

As used in this specification and the appended claims, the singular forms “a,” “an” and “the” include plural referents unless the context clearly dictates otherwise. Thus, for example, reference to “a molecule” includes a plurality of such molecules, and the like.

Certain embodiments may relate to the use of arrays of probes on solid substrates. Methods and techniques applicable to polymer (including nucleic acid and protein) array synthesis have been described in, WO 00/58516, U.S. Pat. Nos. 5,143,854, 5,242,974, 5,252,743, 5,324,633, 5,384,261, 5,405,783, 5,412,087, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,889,165, 5,936,324, 5,968,740, 5,974,164, 5,981,185, 5,981,956, 5,959,098, 6,025,601, 6,033,860, 6,040,193, 6,090,555, 6,136,269, 6,147,205, 6,262,216, 6,269,846, 6,310,189 and 6,428,752, and in WO 99/36760 and WO 01/58593, which are all incorporated herein by reference in their entirety for all purposes. Nucleic acid probe arrays are described in many of the above patents, but the same techniques are applied to many polypeptide probe arrays. Additional techniques for polymer array synthesis include those disclosed within, for example, U.S. Pat. No. 5,143,854 to Pirrung et al.; U.S. Pat. No. 5,744,305 to Fodor et al.; U.S. Pat. No. 7,332,273 to Trulson et al.; U.S. Pat. No. 6,242,266 to Schleifer et al.; U.S. Pat. No. 6,375,903 to Cerrina et al.; U.S. Pat. No. 5,436,327 to Southern et al.; U.S. Pat. No. 5,474,796 to Brennan; U.S. Pat. No. 5,658,802 to Hayes et al.; U.S. Pat. No. 5,770,151 to Roach et al.; U.S. Pat. No. 5,807,522 to Brown et al.; U.S. Pat. No. 5,981,733 to Gamble et al.; and U.S. Pat. No. 6,101,946 to Martinsky, all of which are expressly incorporated herein by reference for all purposes.

Probe arrays have many uses including, but are not limited to, gene expression monitoring, profiling, library screening, genotyping and diagnostics. Methods of gene expression monitoring and profiling are described in U.S. Pat. Nos. 5,800,992, 6,013,449, 6,020,135, 6,033,860, 6,040,138, 6,177,248 and 6,309,822. Genotyping methods, and uses thereof, are disclosed in U.S. Patent Application Publication No. 2007/0065816 and U.S. Pat. Nos. 5,856,092, 6,300,063, 5,858,659, 6,284,460, 6,361,947, 6,368,799, 6,333,179, and 6,872,529. Other uses are described in U.S. Pat. Nos. 5,871,928, 5,902,723, 6,045,996, 5,541,061, and 6,197,506.

Samples can be processed by various methods before analysis. Prior to, or concurrent with, analysis a nucleic acid sample may be amplified by a variety of mechanisms, some of which may employ PCR. (See, for example, PCR Technology: Principles and Applications for DNA Amplification, Ed. H. A. Erlich, Freeman Press, NY, N.Y., 1992; PCR Protocols: A Guide to Methods and Applications, Eds. Innis, et al., Academic Press, San Diego, Calif., 1990; Mattila et al., Nucleic Acids Res., 19:4967, 1991; Eckert et al., PCR Methods and Applications, 1:17, 1991; PCR, Eds. McPherson et al., IRL Press, Oxford, 1991; and U.S. Pat. Nos. 4,683,202, 4,683,195, 4,800,159 4,965,188, and 5,333,675, each of which is incorporated herein by reference in their entireties for all purposes. The sample may also be amplified on the probe array. (See, for example, U.S. Pat. No. 6,300,070, which is incorporated herein by reference in its entirety for all purposes).

Other suitable amplification methods include the ligase chain reaction (LCR) (see, for example, Wu and Wallace, Genomics, 4:560 (1989), Landegren et al., Science, 241:1077 (1988) and Barringer et al., Gene, 89:117 (1990)), transcription amplification (Kwoh et al., Proc. Natl. Acad. Sci. USA, 86:1173 (1989) and WO 88/10315), self-sustained sequence replication (Guatelli et al., Proc. Nat. Acad. Sci. USA, 87:1874 (1990) and WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909 and 5,861,245) and nucleic acid based sequence amplification (NABSA). (See also, U.S. Pat. Nos. 5,409,818, 5,554,517, and 6,063,603, each of which is incorporated herein by reference). Other amplification methods that may be used are described in, for instance, U.S. Pat. Nos. 6,582,938, 5,242,794, 5,494,810, and 4,988,617, each of which is incorporated herein by reference. Additional methods of sample preparation and techniques for reducing the complexity of a nucleic sample are described in Dong et al., Genome Research, 11:1418 (2001), U.S. Pat. Nos. 6,361,947, 6,391,592, 6,632,611, 6,872,529 and 6,958,225.

Hybridization assay procedures and conditions vary depending on the application and are selected in accordance with known general binding methods, including those referred to in Maniatis et al., Molecular Cloning: A Laboratory Manual, 2^{nd} Ed., Cold Spring Harbor, N.Y., (1989); Berger and Kimmel, Methods in Enzymology, Guide to Molecular Cloning Techniques, Vol. 152, Academic Press, Inc., San Diego, Calif. (1987); Young and Davism, Proc. Nat'l. Acad. Sci., 80:1194 (1983). Methods and apparatus for performing repeated and controlled hybridization reactions have been described in, for example, U.S. Pat. Nos. 5,871,928, 5,874,219, 6,045,996, 6,386,749, and 6,391,623 each of which are incorporated herein by reference.

Hybridization generally refers to the process in which two single-stranded polynucleotides bind non-covalently to form a stable double-stranded polynucleotide; triple-stranded hybridization is also theoretically possible. The resulting (usually) double-stranded polynucleotide is a hybrid. The proportion of the population of polynucleotides that forms stable hybrids is generally referred to as the degree of hybridization. Hybridizations are usually performed under stringent conditions, for example, at a salt concentration of no more than about 1 M and a temperature of at least 25° C. For example, conditions of 5× SSPE (750 mM NaCl, 50 mM NaPhosphate, 5 mM EDTA, pH 7.4) and a temperature of 25-30° C. are suitable for allele-specific probe hybridizations or conditions of 100 mM MES, 1 M [Na+], 20 mM EDTA, 0.01% Tween-20 and a temperature of 30-50° C., or at about 45-50° C. Hybridizations may be performed in the presence of agents such as herring sperm DNA at about 0.1 mg/ml, acetylated BSA at about 0.5 mg/ml. As other factors may affect the stringency of hybridization, including base composition and length of the complementary strands, presence of organic solvents and extent of base mismatching, the combination of parameters is more important than the absolute measure of any one alone. Hybridization signals can be detected by conventional methods, such as those described by, e.g., U.S. Pat. Nos. 5,143,854, 5,578,832, 5,631,734, 5,834,758, 5,936,324, 5,981,956, 6,025,601, 6,141,096, 6,185,030, 6,201,639, 6,218,803, 6,225,625, and 7,689,022 and PCT Application PCT/US99/06097 (published as WO 99/47964), each of which is hereby incorporated by reference in its entirety for all purposes.

Certain embodiments may also employ the use of various computer program products and software for a variety of purposes, such as probe design, management of data, analysis, and instrument operation. (See, e.g., U.S. Pat. Nos. 5,593,839, 5,795,716, 5,733,729, 5,974,164, 6,066,454, 6,090,555, 6,185,561, 6,188,783, 6,223,127, 6,229,911 and 6,308,170).

Genetic information obtained from analysis of sensors can be transferred over networks such as the internet, as disclosed in, for instance, U.S. Patent Application Publication Nos. 2002/0183936, 2003/0097222, 2003/0100995, 2003/0120432, 2004/0002818, 2004/0049354, and 2004/0126840.

The design, manufacture and use of various packaging platforms for arrays, including cartridges, pegs, peg strips, peg plates and other platforms, are described in, for example, U.S. Pat. Nos. 5,545,531; 5,945,334; 6,140,044 and 6,660,233, U.S. Patent Application Publication Nos. 2004/0038388; 2005/0023672; 2006/0088863; 2006/0234371; 2006/0246576; 2008/0003667; 2010/0248981; 2011/0136699, and pending U.S. patent application Ser. No. 13/157,268, filed Jun. 9, 2011, all of which are incorporated herein by reference in their entireties for all purposes, and especially for the design, manufacture and use of pegs, sensor strips comprising a plurality of pegs, and sensor plates comprising a plurality of pegs and/or strips, and the compositions, systems and methods for such design, manufacture and use with respect to synthesized arrays on a substrate such as a wafer (whether diced or undiced).

### I. Definitions

Unless defined otherwise, all technical and scientific terms used herein have the same meaning as commonly understood by one of ordinary skill in the art to which the invention pertains. The following definitions supplement those in the art, are directed to the current application, and are not to be imputed to any related or unrelated case, e.g., to any commonly owned patent or patent application. Although any compositions, systems, and methods similar or equivalent to those described herein can be used in the practice of the present invention, the preferred materials and methods are described herein. Accordingly, the terminology used herein is for the purpose of describing particular embodiments only, and is not intended to be limiting.

The term “about” as used herein indicates the value of a given quantity varies by +/−10% of the value, or optionally +/−5% of the value, or in some embodiments, by +/−1% of the value so described.

The term “adhesive” as used herein refers to one or more materials employed to attach a substrate, as defined herein, to a support, also as defined herein. Within most embodiments, adhesives refer to adhesives which are curable by one or more wavelengths of electromagnetic radiation, including but not limited to wavelengths selected from the ultraviolet and/or visible light spectra.

The term “light source” as used herein refers to any suitable source capable of producing electromagnetic radiation, including but not limited to wavelengths selected from the ultraviolet and/or visible light spectra.

The term “secondary support” as used herein refers to a material or combination of materials within one or more components to which one or more supports, as defined herein, are attached, integrated within, formed in conjunction with, or are otherwise associated with. A secondary support may or may not be associated with its one or more supports at the time at which substrates are attached to the one or more supports.

The term “substrate” as used herein refers to a material or combination of materials within one or more components that are attached to a support, as defined herein, through use of an adhesive. Any suitable material or combination of materials may be utilized for a substrate, including but not limited to fused silica, fused quartz, glass, Si, SiO₂, SiN₄, other silicon based materials, Ge, GeAs, GaP, polyvinylidene fluoride, polycarbonate, other polymers, plastics, resins, carbon, metals, and inorganic glasses. Substrates may contain arrays of biological polymers within certain embodiments, but do not possess such arrays in many embodiments.

The term “support” as used herein refers to a material or combination of materials within one or more components to which a substrate, as defined herein, is attached through use of an adhesive. Any suitable material or combination of materials may be utilized for a support, including but not limited to fused silica, fused quartz, glass, Si, SiO₂, SiN₄, other silicon based materials, Ge, GeAs, GaP, polyvinylidene fluoride, polycarbonate, other polymers, plastics, resins, carbon, metals, and inorganic glasses.

The term “structural feature” as used herein refers to a material or combination of materials which is either a component or part of a component of a substrate or support, as both are defined herein, or that form one or more components subsequently associated with a substrate or support. Structural features are employed in various manners within different embodiments, but are used within certain embodiments to provide one or more points of contact between a substrate and support which are distinct from the surface of the substrate and/or support.

The term “tertiary support” as used herein refers to a material or combination of materials within one or more components to which one or more secondary supports, as defined herein, are attached, integrated within, formed in conjunction with, or are otherwise associated with. A tertiary support may or may not be associated with its one or more secondary supports at the time at which substrates are attached to the one or more supports associated with the one or more secondary supports.

### II. Specific Embodiments

Disclosed herein are apparatuses, systems and methods for assembly of a substrate onto a support. Specifically, certain embodiments employ an integrated pick-and-place curing mechanism for the assembly. While the use of certain embodiments is adapted to the assembly of arrays of biological polymers onto a support, other embodiments are easily employed more generally and with respect to many high throughput manufacturing techniques which attach a substrate to a support, especially with respect to relatively small substrates which require a high degree of precision in their attachment. Such embodiments can be applied by one of skill in the art to, for example, the toy, jewelry, computer, electronic, automotive, automation, dental, medical, semiconductor, package and assembly, biotechnology and medical device industries. Certain embodiments relate to methods and apparatuses for packaging sensors, such as packaging arrays of biological polymers.

In general, a substrate and a support can be any two parts desired to be joined together. A substrate and support can be for example, toy parts, jewelry pieces, computer parts, electronic parts, automotive parts, dental parts, medical parts, semiconductor parts, and packaged probe array parts. Other suitable substrates and supports will be readily apparent to those skilled in the art upon review of this disclosure. A substrate and a support material can be made from any material that is compatible with the chemical reactants, processes and other operating environment (such as temperature) of the respective assembly process. For example, certain embodiments employ the use of light through the substrate to activate a light curable adhesive to attach the substrate to the support. Thus, in these embodiments, the substrate is substantially transparent as to allow a sufficient amount of light at the appropriate wavelengths to pass through and activate the relevant photoinitiator of the adhesive. In many embodiments, the material(s) of the support is different than the material(s) of the substrate. Any of a variety of organic or inorganic materials, or combinations thereof, may be employed for the support and substrate, including, for example, metal, plastics such as polypropylene, polystyrene, polyvinyl chloride, polycarbonate, polysulfone, nylon and PTFE, ceramics; silicon based materials, silicon dioxide, fused silica, quartz or glass, and many other materials and combinations of materials known in the art. Depending on the embodiment, the support and substrate may be solid, semi-rigid, flexible or a combination there of and be of any suitable shape. The shape of a support may, for example, be rectangular, diamond, square, circular, oval, cylindrical, any modifications thereof and so forth. A support can be flat, solid, hollow or partially hollow. Furthermore, a support can have various dimensions in length, width and depth. Various dimensions and sizes can be incorporated within various embodiments by appropriate adjustments. For example, certain employ substrates and supports which possess dimensions such that a single curing mechanism, such as an appropriate light source, can cure all of the adhesive at issue. For other embodiments, with a larger or more dimensionally complex substrate and/or support, or a more functionally limited curing mechanism, employ a plurality of curing mechanisms to attach the substrate to the support. The curing mechanisms, such as light sources such as light-emitting diodes (LEDs), may be arranged in any appropriate manner based on the dimensions and configuration of the substrate and support, and thus include, for instance, in a line, in a zig-zag pattern, an “s-shaped” pattern, or in rows and in columns.

Integrated pick-and-place curing methods, systems and apparatuses are additionally advantageous in situations where assembly requires the substrates to be placed onto the support(s) at issue in close proximity to each other. For example, certain embodiments may affix substrates onto different regions of a support with a spacing of 5 mm or less between substrates (e.g., 1.0, 1.5, 2.0, 2.5, 3.0, 3.5, 4.0, 4.5, 5.0 mm). Such precision is facilitated, in part, by integrated combination of picking and placing the substrate with the curing of the adhesive. Approaches which do not integrate the picking and placing of the substrate with the curing are susceptible to undesired placement issues caused by positional changes of the substrate relative to the support. Even when such positioning changes are small on a quantitative measure, the resulting issues can impose significant difficulties in subsequent use of the substrate-support complex as the relevant dimensions become smaller.

In some embodiments, the substrate includes a sensor, such an array of biological polymers, often referred to as a microarray or probe array. Furthermore, within certain embodiments, the array has already been synthesized, spotted or otherwise attached to the substrate at the time at which the substrate is attached to the support. Thus, within some embodiments, the substrate may comprise one or more materials such as silica, fused silica, quartz, glass or other silicon based materials in the form of a wafer (diced or undiced), slide, etc. In addition to the array of biological polymers, one or more surfaces of the substrate may possess other aspects, such as one or more coatings of functionalized silicon compounds, materials with desired optical properties (e.g., absorptive coatings, anti-reflective coatings, index matching coatings, combinations thereof), protective coatings (e.g., to reduce the effect of wear and tear, to prolong shelf life), or other additions to the substrate that may be desired for the particular embodiment at issue. Thus, the surface may be composed of any of a wide variety of materials, for example, polymers, plastics, resins, polysaccharides, silica or silica-based materials, carbon, metals, inorganic glasses, membranes, or any of the above-listed substrate materials.

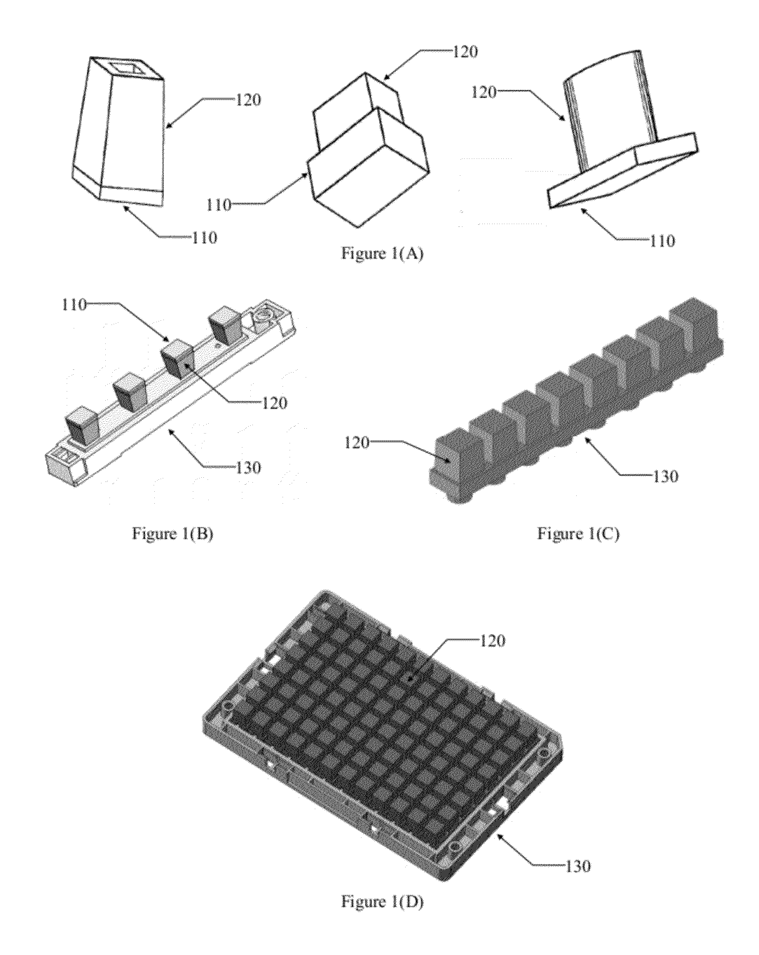

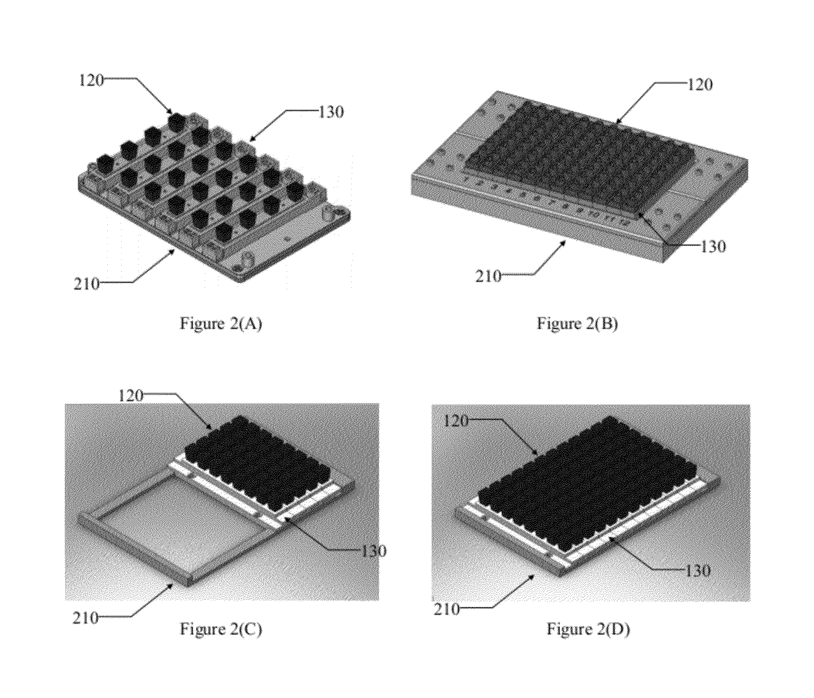

Certain embodiments disclosed herein are directed to methods, systems and apparatuses for the attachment of a substrate which may contain a sensor, such as a biological sensor (e.g., a nucleic acid microarray or a polypeptide microarray synthesized, spotted or otherwise attached to a substrate), to a support (e.g., a peg in the shape of a rectangular prism, cylinder, or pyramid with a flat top). Within some embodiments, these supports are then attached, inserted or otherwise assembled into a secondary support. By assembling multiple supports into a secondary support, an array of sensors may be formed (which may also be known as an array of arrays). For example, FIG. 1(A) includes three non-limiting examples of pegs. These pegs serve, within certain embodiments, as the support onto which an appropriate substrate is attached. At the time of attachment, such supports may, but not necessarily, already have the array of biological polymers synthesized, spotted or otherwise attached on the substrate. Specifically, as depicted within FIG. 1(A), each peg consists of a substrate 110 which has been attached to a support 120. As stated above, substrate 110 may possess an array of biological polymers, such as a nucleic acid microarray or polypeptide microarray. This array may be positioned, for example, on the surface of substrate 110 which faces away from support 120.

Supports, such as pegs, may also be incorporated into secondary supports, such as a strip or plate. FIG. 1(B) illustrates a non-limiting example of a secondary support 130, to which four supports 120 have been attached, with each support 120 possessing a substrate 110. In the particular embodiment illustrated, a peg strip with 4 pegs is shown, with each peg possessing an array of oligonucleotides. However, other embodiments possess different numbers of support 120 on the secondary support 130. For example, FIG. 1(C) depicts an alternative form where secondary support 130 possesses eight supports 120. Other embodiments employ other forms for secondary support 130, as can be seen within the non-limiting depiction of FIG. 1(D), which portrays secondary support 130 as a plate of supports 120 in rows and columns. Many variants of the embodiments depicted within FIGS. 1(B)-1(D) would be evident to one of skill in the art based upon the disclosure herein. For instance, other embodiments may utilize a secondary support 130 which possesses a different number of supports 120. For example, for the secondary supports 130 in strip format, such as the non-limiting examples depicted within FIGS. 1(B) and 1(C), many other quantities of supports 120 may be employed, such as from 1-24 supports 120, including 1, 2, 3, 4, 5, 6, 7, 8, 9, 10, 11, 12, 16, 18, or 24 supports 120. Other embodiments may employ even higher quantities of supports 120. Likewise, other embodiments of secondary support 130 in a plate format may possess different quantities of supports 120. For example, certain embodiments of secondary support 130 possess 24, 36, 96, 384, or 1536 supports 120. Alternative embodiments may also possess supports 120 in a format other than rows and columns.

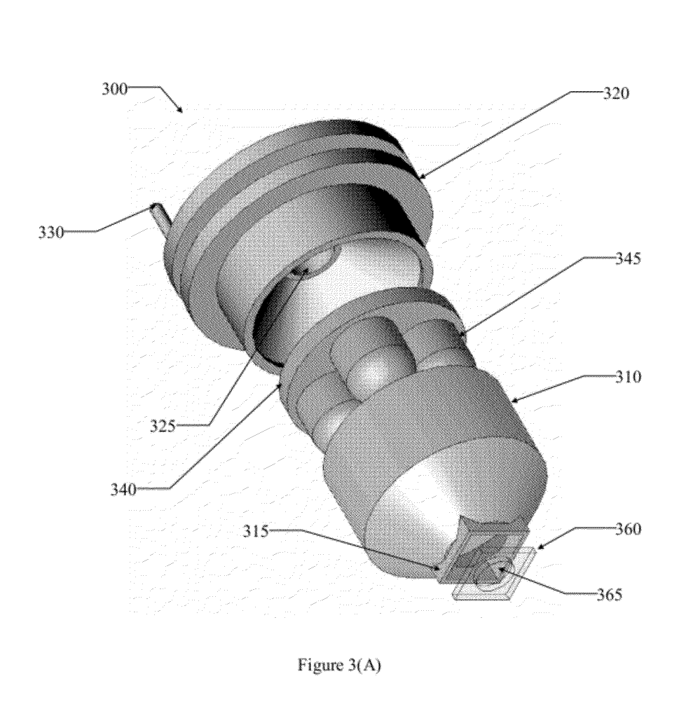

FIGS. 2(A)-2(D) illustrate four non-limiting examples of a tertiary support 210 which incorporates one or more secondary supports 130 which each possess one or more supports 120. FIG. 2(A) illustrates a non-limiting example where the tertiary support 210 incorporates six secondary supports 130, each of which possess four supports 120. FIG. 2(B) illustrates an alternative embodiment, with tertiary support 210 incorporating the use of 12 secondary supports 130. Each secondary support 130 within FIG. 2(B) possesses 8 supports 120, thus providing a total of 96 supports 120 for tertiary support 210. Such quantities (and related quantities such as 384 or 1536) of supports 120 may be particularly convenient for certain assays where multiple samples are simultaneously processed at least partially within microtiter plates. FIGS. 2(C)-2(D) illustrate alternative forms of tertiary support 210. Specifically, the embodiment illustrated possesses an adjustable number of secondary supports 130 as seen by the tertiary support 210 within FIG. 2(C) possessing 5 modular units of secondary supports 130, while the tertiary support 210 within FIG. 2(D) possessing 12 secondary supports 130. Such flexibility enables, for instance, the ability to mix and match different secondary supports 130 within a single tertiary support 210. Such flexibility provides advantages when, for example, different substrates 110 (e.g., different arrays of oligonucleotides) are attached to the supports 120 of one secondary support 130 in comparison to the substrates 110 attached to the supports 120 of a different secondary support 130 which is also attached to the same tertiary support 210.

It should be noted, however, that configurations of supports 120, secondary supports 130 and tertiary supports 210 is not limited to the exemplary illustrations. Many other variations are known in the art, including those described within, for example, U.S. Pat. Nos. 5,545,531; 5,945,334; 6,140,044 and 6,660,233, U.S. Patent Application Publication Nos. 2004/0038388; 2005/0023672; 2006/0088863; 2006/0234371; 2006/0246576; 2008/0003667; 2010/0248981; 2011/0136699, and pending U.S. patent application Ser. No. 13/157,268, filed Jun. 9, 2011, all of which are incorporated herein by reference in their entireties for all purposes. Furthermore, as stated above, many other configurations and dimensional designs are compatible with various embodiments disclosed herein, including configurations and dimensional designs which are unrelated to the attachment of a substrate 110 in the form of an array of biological polymers on a solid support to a support 120 in the form of a peg.

The modular version of secondary supports 130 are particular useful for substrates 110 that possess sensors such as probe arrays synthesized, spotted or attached to a surface, for example, a microarray of nucleic acid probes, such as GeneChip® arrays and Axiom® array plates available from Affymetrix, Inc. (Santa Clara, Calif.). Such nucleic acid arrays have a variety of applications in analyzing nucleic acid samples, such as in gene profiling, copy number analysis, drug metabolism analysis, genome-wide genotyping, molecular cytogenetics, resequencing analysis, targeted genotyping analysis, expression analysis, gene regulation analysis, miRNA analysis, and whole-transcript expression analysis and profiling. In many such applications, it is preferred to analyze many samples in parallel for the same data (e.g., analyzing all the participants within a clinical study). Furthermore, many end-users will have different groups of samples with which they want to perform certain types of analyses with at any given time. Thus, high throughput formats of arrays are preferred for the processing of large quantities of samples with either the same array or a combination of different arrays within the same secondary support 130 or tertiary support 210. However, the use of high throughput formats imposes new and distinct requirements on manufacturing and quality control. For example, a defect in the manufacturing of a tertiary support 210 which incorporates dozens of supports 120 can cause the loss of all of the attached substrates 110, as opposed to a manufacturing defect merely causing the loss of a single support 120 and its attached substrate 110 in a corresponding non-high throughput counterpart. Furthermore, depending on the design and configuration of any relevant secondary supports 130 and/or tertiary supports 210, manufacturing tolerances may be stricter within high throughput designs, and thus the corresponding manufacturing apparatuses (e.g., the apparatus(es) for picking, placing and curing the substrate 110 to the support 120) will have a smaller margin for error during operation. These and other related factors have created a need for integrated apparatuses, systems and methods to pick, place and cure a substrate 110 to a support 120 for the purposes of accurate, effective and efficient attachment of the substrate 110 to the support 120.

### Pick-and-Place Curing Apparatus, System and Method

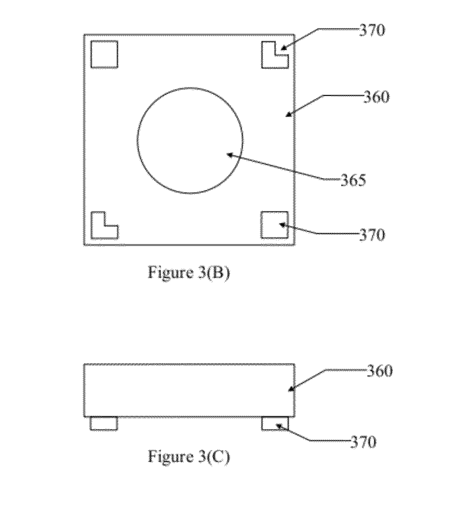

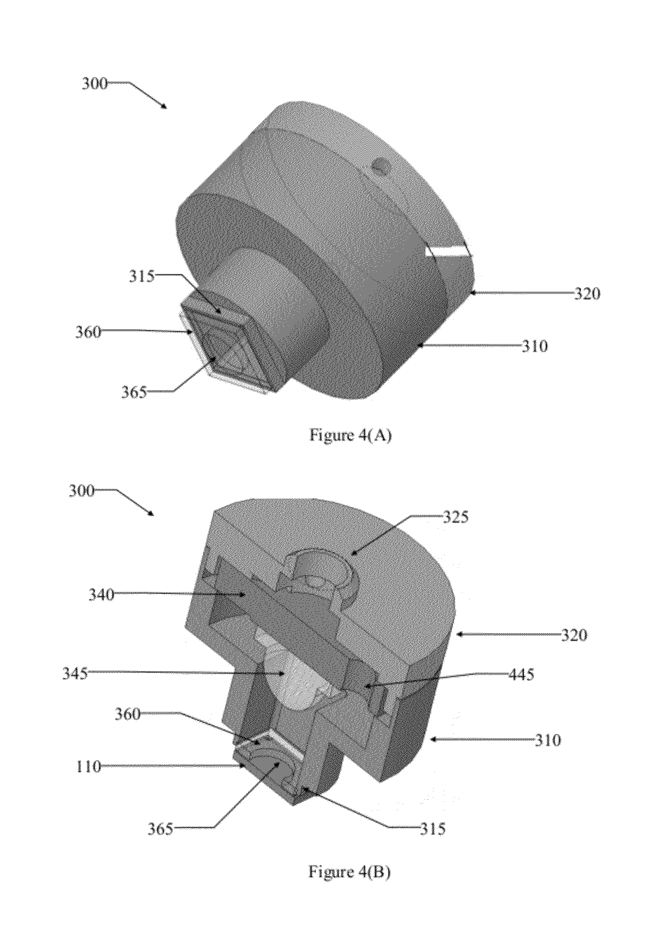

FIGS. 3, 4(A)-4(B), 5(A)-5(C) and 6(A)-6(C) illustrate non-limiting examples of pick-and-place curing apparatuses for use within certain embodiments disclosed herein. Many of these embodiments are directed to the use of an apparatus which combines a pick-and-place functionality with an additional functionality for the curing of an appropriate adhesive such that a substrate 110 is collected from one location, placed precisely in a second location (e.g., on support 120), and the relevant adhesive cured through the use of a single apparatus.

Different embodiments employ various components and methods for the picking of substrate 110. Certain embodiments employ a mechanical gripper to hold substrate 110 as is desired within a particular embodiment. For example, if substrate 110 possesses an array of biological polymers, then the mechanical gripper will preferably not come into physical contact with any portion of the array such that the potential for possible damage to the array is minimized. Many embodiments, however, employ vacuum to pick the substrate 110 and place it as desired. These embodiments may utilize any suitable vacuum approach, with several non-limiting configurations illustrated within FIGS. 3, 4(A)-4(B), 5(A)-5(C) and 6(A)-6(C). The exact details for a vacuum approach will vary depending on the embodiment and factors such as the dimensions and mass of substrate 110, the required degree of movement and transport of substrate 110 to support 120, the design, configuration and adaptability of the integrated pick-and-place curing apparatus and system, and other factors known in the art. As with a mechanical gripping approach, certain embodiments employing a vacuum approach will also avoid contact with certain surfaces or portions of substrate 110 which may be sensitive to physical contact, such as a portion of a particular substrate 110 which possesses an array of biological polymers. Furthermore, the use of a vacuum approach is preferred within many embodiments as it facilitates the immobilization of substrate 110 in a single position relative to the apparatus from the moment vacuum is applied, through any movement and transportation of the substrate 110, and through the process of attaching substrate 110 to a support 120. Then, once the selected means for attaching substrate 110 to support 120 is complete (which may vary depending on the embodiment and the selected technique for attachment), the vacuum is removed and the apparatus disengaged, resulting in substrate 110 being attached to support 120 as desired.

Many types of adhesives are known in the art and may be employed within certain embodiments, such as non-reactive adhesives (e.g., drying, pressure sensitive, contact or hot adhesives) or reactive adhesives (e.g., light cured, ultraviolet light cured, multi-component, heat cured, or moisture cured adhesives), natural adhesives, or synthetic adhesives. Light curable adhesives, such as adhesives cured with ultraviolet and/or visible light, offer advantages within many embodiments, including the ability to cure rapidly and only upon use of appropriate illumination, the efficiency and consistency provided through use of a one component adhesive, and the adaptability of various formulations to be modified for use within a range of embodiments.

Many variations of light curable adhesives are commercially available, such as from Dymax Corporation (Torrington, Conn.). Depending on the embodiment, suitable light curable adhesives include the non-limiting examples of cationic epoxies and acrylates utilizing a urethane backbone). Selection of the appropriate adhesive and the other mixture components involved (e.g., photoinitiators, thickeners, modifier for the desired hardness) will depend on a variety of factors, such as the depth of the cure necessary based on the amount of adhesive employed, the material(s) of substrate 110 and support 120 and their adhesion characteristics for the adhesive at issue, and the degree and type of resistances required with respect to potential solvents that may be encountered. Furthermore, the selection of an appropriate adhesive will often be significantly associated with the light source to be utilized. Many light curable adhesives require radiation comprising wavelength(s) in a portion of the ultraviolet spectrum and/or visible spectrum (e.g., a broadly curable adhesive may utilize light from 200-500 nm, while other light curable adhesives may employ smaller ranges such as 200-250, 240-280, 275-325, 320-350, 360-390, 375-425, 400-440, 440-480, 450-500). Additionally, some light sources may possess a narrow output (e.g., 350, 380, 455, 475 nm) or possess an output within a certain range (e.g., 440-480 with a peak of 455 nm). The selection process will also be guided by the properties of the substrate 110 and support 120. For instance, certain embodiments are directed to substrates 110 with possess arrays of biological polymers, such as oligonucleotides, on a surface of substrate 110. Nucleic acids such as DNA can be damaged by irradiation of ultraviolet wavelengths within the lower bounds of the ultraviolet spectrum (e.g., below 340 nm). Thus, if a particular substrate 110 incorporates substances/materials which may be damaged by a certain wavelength, the choice of adhesive and light source must be adapted accordingly. In addition to potentially sensitive substances or materials, the subsequent effect on the use substrate 110 of the adhesive at issue may also be relevant in certain embodiments. For example, if substrate 110 is subsequently utilized with optical instruments, selection of an inappropriate adhesive may cause undesirable optical results (e.g., unwanted refraction, absorption, reflection). Furthermore, the intensity of the light source to be utilized is also chosen with respect to the light curable adhesive at issue.

Different embodiments may employ light sources with varying intensity values depending on the adhesive of choice, the desired curing time, and other factors known in the art. For example, certain embodiments may employ light source(s) which create an illumination for the adhesive between the substrate and support with intensity values between 500 and 2000 milliwatts/cm². Other embodiments may employ light sources resulting in intensity values below or above this range, as may be required or desirable within the design of a particular embodiment. An advantage of embodiments herein is the placement of the light source within the body of the apparatus such that the illumination is emitted: (1) in close proximity to the adhesive, (2) on a direct path to the adhesive between the substrate and support. The combination of these factors provides advantages such as allowing less powerful light sources to provide adequate curing of the adhesives due to the closer proximity and more direct illumination, and also a more consistent and effective of all the adhesive at issue due to the direct path of the illumination such that the adhesive receives substantially uniform illumination (as opposed to illuminating from the edges of the substrate-support, or a position off to one side of the substrate-support). These aspects are not possible within prior approaches where the light source and pick-and-place apparatus were not integrated, and such prior approaches thus less effective and consistent. Many suitable light sources are known for use with light curable adhesives, including but not limited to spot lamps, focused-beam lamps, flood lamps, fluorescent lamps with a modified phosphorescent coating, a variety of light-emitting diodes (LEDs), laser diodes, solid-state lasers and other light sources. Many LEDs constructed from a variety of inorganic semiconductor materials may be utilized within various embodiments, including those with ultraviolet, violet and blue outputs.

Previous approaches for carrying out pick-and-place and curing of a substrate with respect to a support involved a plurality of apparatuses and/or curing periods. For example, a common approach was to pick-and-place the substrate with one apparatus and cure with another. Furthermore, within applications where the substrate was preferably immobilized throughout the process until at least portions of the adhesive are substantially cured, effectiveness, efficiency and precision was often hindered by the need for immobilization, with the pick-and-place apparatus blocking key portions of the adhesive from receiving sufficient amounts of curing radiation and thus necessitating a plurality of curing periods. In turn, this often led to adhesive voids and wicking, incomplete curing, disadvantageous outgassing, and other associated effects. Disclosed herein are certain embodiments which solve these issues by providing apparatuses, systems and methods for an integrated pick-and-place curing approach for the attachment of substrates 110 to supports 120.

FIG. 3(A) depicts a non-limiting example of an integrated pick-and-place curing apparatus 300 for use in attaching a substrate 110 to a support 120. In this particular embodiment, apparatus 300 includes a housing 310, an attachment component 320, and a printed circuit board 340. Printed circuit board 340 is designed to attach to, interlock with, or be inserted within housing 310. In addition to containing components for other functions, printed circuit board 340 includes one or more light sources 345, such as LEDs or other suitable light sources for curing light curable adhesives. Printed circuit board 340 may also provide other functions, such as thermal and/or electrical insulation through the use of thermal/electrical coatings or the selection of components for printed circuit board 340 with certain thermal/electrical properties. Housing 310 includes a substrate contact component housing 315, which contains an opening through which the light from light source 345 proceeds through in order to activate the photoinitiators of the adhesive and begin the curing reaction. Placement of light source 345 within the housing and in close proximity to where substrate 110 will be held by apparatus 300 allows a greater percentage of the output illumination to be directed at the light curable adhesive.

Attachment component 320, which includes vacuum port 325 and locator pin 330, serves several purposes. First, attachment component 320 serves to connect apparatus 300 to the relevant overall system for attaching substrate 110 to support 120. Through attachment component 320, apparatus 300 receives, for example, electrical power (e.g., electrical power for light source 345), supply of the necessary vacuum, etc. The source of the vacuum may be any suitable source capable of adaptation with apparatus 300 as long as sufficient vacuum is generated for the purposes of picking and placing substrate 110, and retaining substrate 110 until bonding of the light curable adhesive is complete and the vacuum source is deactivated. Vacuum port 325 facilitates the vacuum proceeding through attachment component 320 and through housing 310 (with one or more additional openings within printed circuit board 340 if necessary, depending on the design and precise configuration of printed circuit board 340 with respect to housing 310). Locator pin 330 may be employed within certain embodiments to guide the process of mating apparatus 300 to other components within the overall system, specifically by guiding the interaction of attachment component 320. Within some embodiments, the proper utilization of locator pin 330 is important to, for example, prevent air leaks. Attachment component may be attached to the overall system through any suitable means. For instances, some embodiments employ a collet approach for connecting apparatus 300 to the overall system which provides the vacuum source and electrical power for light source 345. Other embodiments employ a magnet to hold apparatus 300, which then requires attachment component 320 to be made of a suitable material with respect to the magnet at issue.

As mentioned, housing 310 includes substrate contact component housing 315, which is designed to accommodate substrate contact component 360. Housing 310, as with other components of apparatus 300, may be made in any suitable manner (e.g., molded or machined) from any suitable material(s). Within certain embodiments, housing 310 is made from stainless steel or aluminum. Substrate contact component 360 is the primary component of apparatus 300 which comes into contact with substrate 110. Substrate contact component 360 includes substrate contact component opening 365 to allow the vacuum to be applied to substrate 110. While substrate contact component 360 is illustrated within FIG. 3(A) to be a square, and substrate contact component opening 365 is illustrated as a circle, both components may be any suitable shape and of any suitable dimensions depending upon the substrate 110 and support 120 at issue. For example, substrate contact component 360 may be in the shape of a rectangle, circle, diamond, pentagon, hexagon, octagon, etc., and may also be irregular and non-polygonal shapes as may be necessitated by the particular substrate 110 at issue.

Furthermore, substrate contact component 360 may possess structural features 370, such as components to ensure that only certain portions of substrate contact component 360 come into actual contact with substrate 110. For example, if a portion of the surface of substrate 110 which would otherwise come into contact with substrate contact component 360 comprises sensitive material or substances (e.g., oligonucleotides of an array of biological polymers), then substrate contact component 360 may have various structural features 370, such as slight protrusions, ridges, frames, etc. to ensure that only certain areas of substrate 110 come into contact with substrate contact component 360, with selection of those areas chosen to avoid damage to or otherwise alteration of the sensitive material or substances on substrate 110. Thus, some embodiments employ structural features 370 on substrate contact component 360 as “stand-off features” such that only these features come into contact with substrate 110 regardless of the overall configuration of substrate contact place 360 and substrate 110. For example, a square shaped substrate contact component 360 may possess four protrusions (e.g., chrome markers), one each in its four corners, such that only these corners in the protrusions come into direct contact with substrate 110. These structural features 370 may of any suitable size and shape, and need only extend from substrate contact component 360 as far as is required to prevent the desired areas of the surface of substrate 110 from coming into contact with substrate contact component 360. A non-limiting example of a substrate contact component 360 with such structural features is depicted within FIGS. 3(B)-3(C).

Additionally, the substrate contact component 360 can be designed such that only acceptable areas of substrate 110 are contacted by substrate contact component 360. For instance, if a square shaped substrate 110 possesses a top surface which is covered with oligonucleotides except for a 0.2 mm border on all sides of substrate 110, then substrate contact component 360 may be designed such that the plate only contacts the outer 0.15 mm border of substrate 110.

These embodiments can be combined with substrates 110 which have corresponding structural features, whether in a mirroring configuration, interlocking configuration, etc. to additionally ensure that sensitive areas of substrate 110 are not contacted by substrate contact component 360. Furthermore, some embodiments employ structural features 370 on the substrate 110 and/or substrate contact component 360 to further guide the alignment of substrate 110 with apparatus 300. These alignment features may, for example, interlock with one another, interface with one another, contact one another, or otherwise interact and guide the precise picking of the substrate 110 by apparatus 300. Additionally, certain embodiments employ associated vision systems with alignment features to guide apparatus 300 with respect to picking and/or placing substrate 110. The vision system may, for instance, detect the alignment features (serving as fiducial markers) on the substrate 110 and/or substrate contact component 360 and/or support 120 to guide placement. For example, depending on the positioning of substrate 110 when apparatus 300 first applies the vacuum to pick-up substrate 110, there is a possibility that substrate 110 may be in an altered rotation. Thus, the use of fiducial markers or other features can allow a vision system to identify the precise rotation, rotate apparatus 300 accordingly to make any necessary rotational alignments, and then place substrate 110 on support 120.

Within many embodiments, the material(s) from which substrate contact component 360 are constructed are selected in view of the particular wavelengths from light source(s) 345 which will be utilized to activate the photoinitiators of the relevant adhesive(s). For example, if a particular embodiment employs an adhesive which cures upon illumination of light at 450-470 nm, then substrate contact component 360 will preferably have a high transmittance and low reflectance with respect those wavelengths. For example, selection of material(s) for substrate contact component 360 such that the wavelength(s) supplied by light source 345 that are relevant to the adhesive at issue result in a substrate contract component 360 with a transmittance of at least 50, 55, 60, 65, 70, 75, 80, 85, 90 or 95% while also having a reflectance for these wavelengths of less than 50, 45, 40, 35, 30, 25, 20, 15, 10 or 5%. For instance, if a particular light curable adhesive to be employed is most effectively cured with illumination from 455-465 nm, then substrate contact component 360 may possess, within an embodiment, a transmittance of at least 75% and a reflectance no greater than 25% for 455-465 nm. Non-limiting examples of materials suitable for use within a substrate contact component 360 within certain embodiments include, glass, fused quartz, borosilicate glass, soda-lime glass, ceramics, polycarbonate, polyethylene, and other materials known in the art. The design and construction of contact plate housing 315 and substrate contact component 360 will additionally depend upon other factors, such as the configuration of the portion of substrate 110 to be bonded with support 120. For example, a specific embodiment possess a contact plate housing 315 and substrate contact component 360 that is substantially the same size of the portion of substrate 110 on which the adhesive will be applied and bonded with support 120. Thus, in this embodiment, there is direct radiation from light source 345 through substrate contact component 360 to substantially all of the adhesive between substrate 110 and support 120. Such embodiments foster more complete curing of all of the adhesive, a faster curing process, and the facilitation of performing all of the curing necessary with respect to a particular substrate 110 and support 120 in one process for a more standardized, effective and efficient process in comparison to other approaches which employ two or more curing phases.

In many embodiments, operation of one more aspects (e.g., illumination of the light curable adhesive, activation/deactivation of vacuum, movement of apparatus 300) is controlled by a computer. The computer may contain machine-readable instructions relating to, for instance, duration of cure time, movement instructions, selection of appropriate light sources (e.g., if an apparatus includes multiple light sources 345 to enable curing of different adhesives requiring different types of illumination), and other aspects.

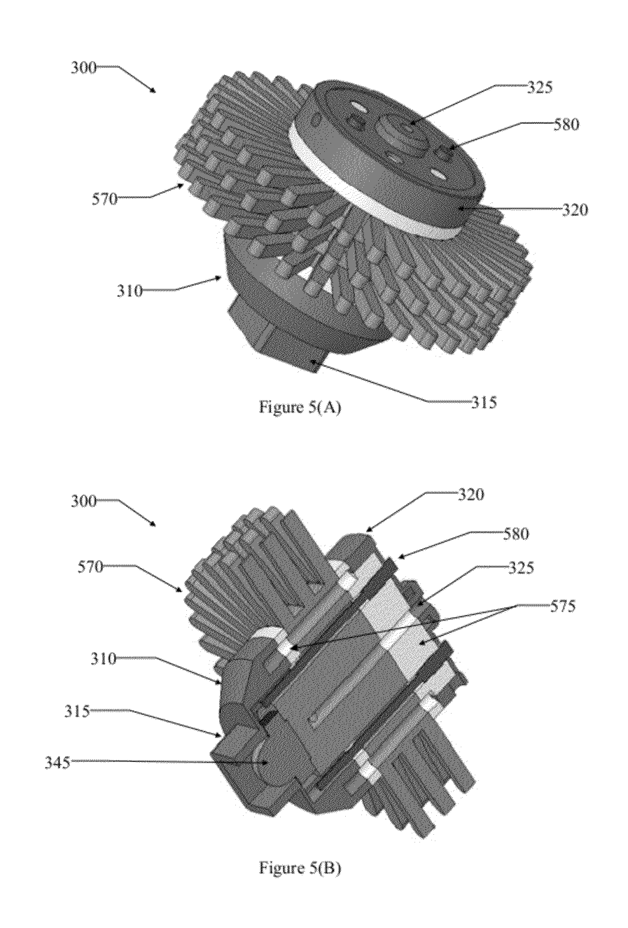

FIGS. 4(A)-4(B) illustrate another non-limiting example of apparatus 300. FIG. 4(A) depicts an external overview while FIG. 4(B) depicts a cross-sectional view. As seen within FIG. 4(A), this non-limiting example of an apparatus 300 also includes housing 310 and attachment component 320. Housing 310 includes substrate contact component housing 315, which is adapted for use with substrate contact component 360. As before, substrate contact component 360 includes a substrate contact component opening 365 to allow the vacuum to be applied to substrate 110.

FIG. 4(B) illustrates a cross-sectional view of this exemplary apparatus 300, including housing 310 and attachment component 320. As depicted, the interior of apparatus 300 includes printed circuit board 340 and light source 345. Vacuum port 325 and interior vacuum port 445 facilitate the vacuum connection between the vacuum source connected to apparatus 300 and substrate contact component opening 365 of substrate contact component 360 within substrate contact component housing 315. Furthermore, this particular depiction of apparatus 300 includes a non-limiting illustration of substrate 110 as substrate 110 is held by the exerted vacuum against substrate contact component 360.

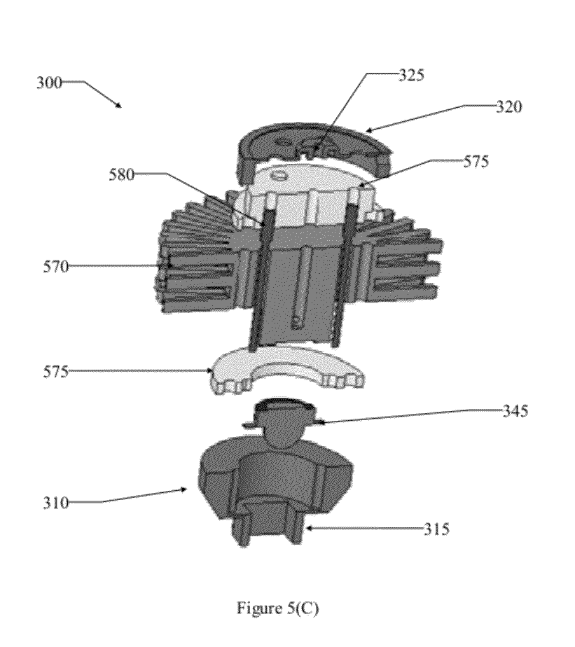

FIGS. 5(A)-5(C) illustrate another non-limiting example of apparatus 300. FIG. 5(A) depicts an external overview of the assembled apparatus 300, FIG. 5(B) depicts a cross-sectional view, and FIG. 5(C) depicts an exploded, disassembled view of apparatus 300. As seen within FIG. 5(A), apparatus 300 includes housing 310 and attachment component 320. Attachment component 320 includes vacuum port 325. Apparatus 300 includes substrate contact component housing 315. An addition to the particular non-limiting embodiment illustrated within FIGS. 5(A)-5(C) is a heat sink 570 and electrical connections 580. Electrical connections 580 provide a path for electrical power to be supplied to the apparatus (e.g., the light source 345). Certain embodiments employ a heat sink 570 adapted to transfer heat generated by operation of apparatus 300 (e.g., heat generated through the use of light source 345) to the air surrounding apparatus 300. Heat sinks may also be employed for other purposes, such as prolonging the life of light source(s) 345 by providing improved operating conditions. Furthermore, while heat sink 570 is depicted with fin-like structures to provide a large surface area with which to dissipate heat, any suitable configuration may be employed in other embodiments. For example, other embodiments possess heat sinks 570 in the form of rods, pins, sheets, combinations thereof, or other configurations. Heat sinks 570 may utilize any suitable material, including but not limited to aluminum, copper, silver and other alloys. Additionally, the heat sink 570 may be associated with heat generating components (e.g., light source 345) through any suitable means for the particular embodiment at issue. For instance, certain embodiments may employ a thermal epoxy or equivalent approach to connect various components. Not all embodiments employ the use of a heat sink 570, as such a feature will depend on a variety of factors including the overall manufacturing conditions to be employed, the type of light source 345 and the amount of heat generated through its use, the number of light source(s) 345 employed, and other factors known in the art. Furthermore, other embodiments employ alternative cooling mechanisms depending on the requirements of apparatus 300, including, for instance, fans, forced air cooling, or liquid cooling approaches.

FIG. 5(B) depicts a cross-sectional view and FIG. 5(C) an exploded, disassembled view of the same apparatus 300. These views illustrate housing 310, substrate contact component housing 315, attachment component 320 and vacuum port 325. In addition to heat sink 570, apparatus 300 employs insulation components 575 with respect to, for instance, thermal and/or electrical insulation. In this particular example of apparatus 300, insulation components 575 aid in the direction of retention of generated heat by heat sink 570, which is in connection with light source 345. Insulation component 575 may be configured in any appropriate manner and comprise any appropriate material, including but not limited to the examples of Delrin® acetal resin (E.I. du Pont de Nemours and Company, Wilmington, Del.), polyether ether ketone (PEEK), and FR-4 epoxy. Many other suitable materials for insulation component 575 will be apparent to those of skill in the art. Furthermore, embodiments may employ one or more insulation components 575 in different areas of apparatus 300 as may be required or desirable within a particular embodiment. FIGS. 5(B)-5(C) also include electrical connections 580.

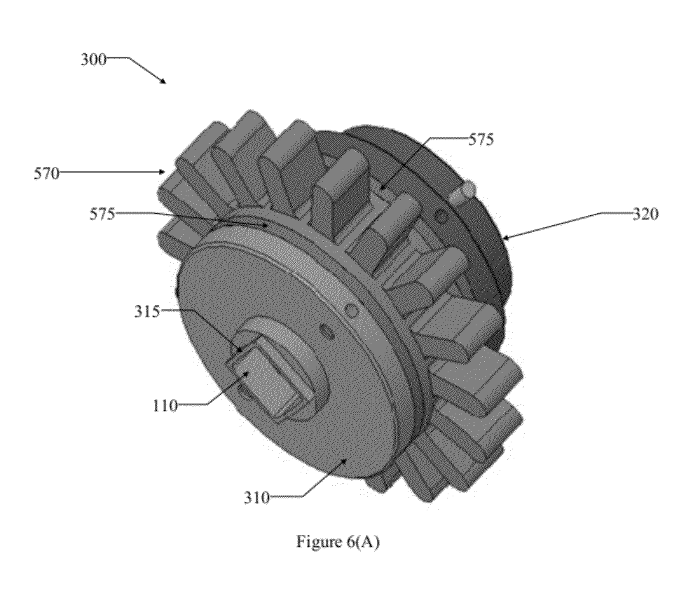

FIGS. 6(A)-6(C) illustrate another non-limiting example of apparatus 300. FIG. 6(A) depicts an assembled view, FIG. 6(B) an exploded, disassembled view, and FIG. 6(C) a cross-sectional view. FIG. 6(A) illustrates an apparatus 300 with a housing 310, attachment component 320, heat sink 570, two insulation components 575 in the form of insulation washers, and substrate contact component housing 315. Also depicted is a substrate 110. FIGS. 6(B)-6(C) also illustrate these aspects. Additionally, FIG. 6(C) shows light source 345, vacuum port 325 and interior vacuum port 445.

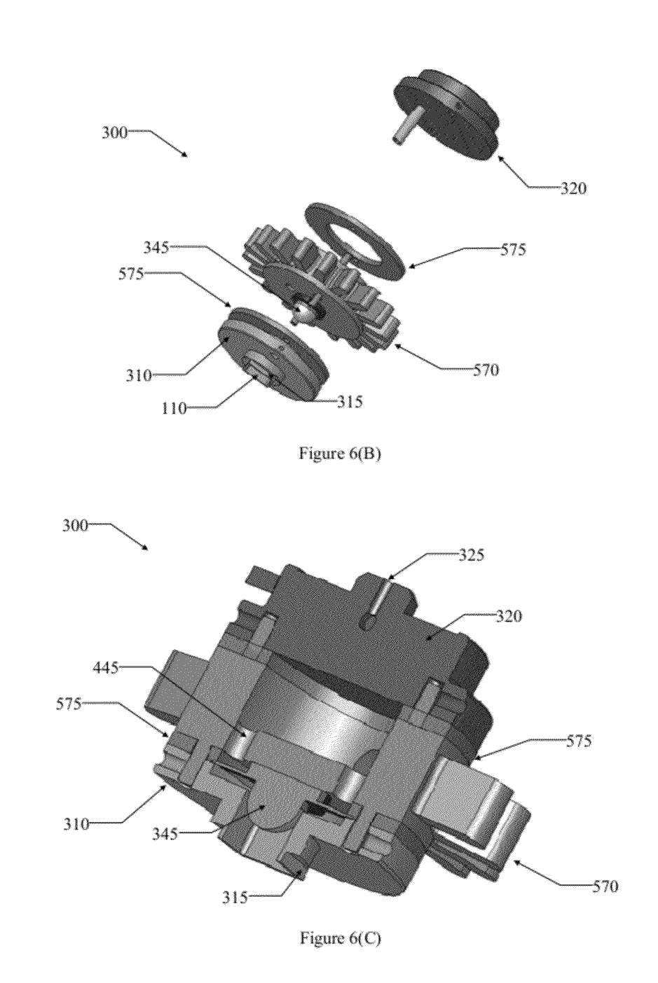

The particular embodiment illustrated within FIGS. 6(A)-6(C) is one where substrate 110 may be initially picked-up while in a slightly rotated state (e.g., substrate 110 is not perfectly aligned with substrate contact component 360, which is obscured from view within FIG. 6(A)-6(B) by substrate 110). Thus, such embodiments may employ, for example, a vision system to detect the particular orientation in which substrate 110 is held, and rotate apparatus 300 accordingly before placing substrate 110 into contact with the adhesive on support 120. For example, two potential situations with respect to substrate 110 and rotation are depicted within FIGS. 7(A)-7(B). If substrate 110 is desirably picked by apparatus 300 within the conformation illustrated within FIG. 7(A), the relevant vision system will be programmed to identify such a rotation based upon the use of fiducial markers 715. Fiducial markers 715 may be any suitable shape and material based on the vision system (e.g., chrome to produce a high reflectance). However, if the vision system detects a configuration of fiducial markers 715 indicating a rotation 725, then apparatus 300 can then be rotated to compensate and apply substrate 110 to adhesive bearing support 120 with the proper rotation. Certain embodiments incorporate a threshold rotation value to determine whether apparatus 300 is rotated, or whether no rotation is to be performed based upon a comparison of rotation 725 to a predetermined optimal rotation.

Additionally, such fiducial markers 715 may also be employed within certain embodiments in combination with structural features 370 as illustrated and described for FIGS. 3(B)-3(C). FIG. 3(B) depicts substrate contact component 360 from below while FIG. 3(C) depicts a view from a horizontal perspective. For example, if a substrate 110 as illustrated within FIGS. 7(A)-7(B) were employed in combination with an apparatus 300 which included a substrate contact component 360 as illustrated within FIGS. 3(B)-3(C), the fiducial markers 715 and structural features 370 are then employed to ensure that substrate contact component 360 does not actually contact substrate 110. Instead, only the fiducial markers 715 will come into contact with structural features 370, and the vacuum applied through substrate contact component opening 365 will maintain that contact until substrate 110 is to be disassociated from apparatus 300. The particular non-limiting depictions within FIGS. 3(B) and 7(A) appear to be mirror images as FIG. 3(B) displays the bottom surface of substrate contact component 360 and FIG. 7(A) displays the top surface of substrate 110, which thus results in matching combination when the substrate contact component 360 approaches substrate 110 from above.

### Simultaneous Placement and Attachment of a Plurality of Substrates

Certain embodiments employ alternative routes for the placement and attachment of a substrate 110 with the associated supports 120 and/or secondary support 130 and/or tertiary support 210, specifically when multiple substrates 110 are desirably placed and attached simultaneously. For example, while many embodiments of the above described apparatuses, systems and methods for picking, placing and curing a substrate 110 to a support 120 are directed to doing so for a single substrate 110 at a particular time, other embodiments seek to do so for a plurality of substrates 110. It is the goal of certain embodiments to facilitate means to, for instance, attach all four substrates 110 to the four supports 120 of secondary support 130 within FIG. 1(B) simultaneously, which may occur in such an embodiment after attachment of the supports 120 with the secondary support 130. This concept is easily scaled, to accomplish, for example, the simultaneous attachment of 96 substrates 110 with the 96 supports 120 of secondary support 130 within FIG. 1(D). Such simultaneous placement and attachment can enable significant gains in efficiency of the overall process.

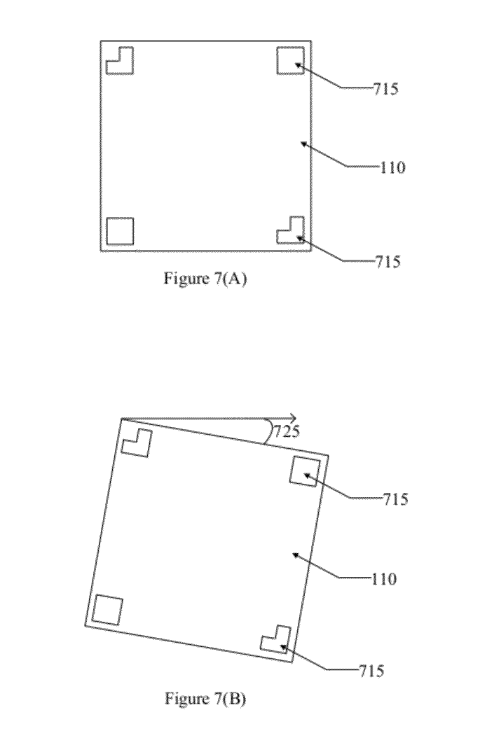

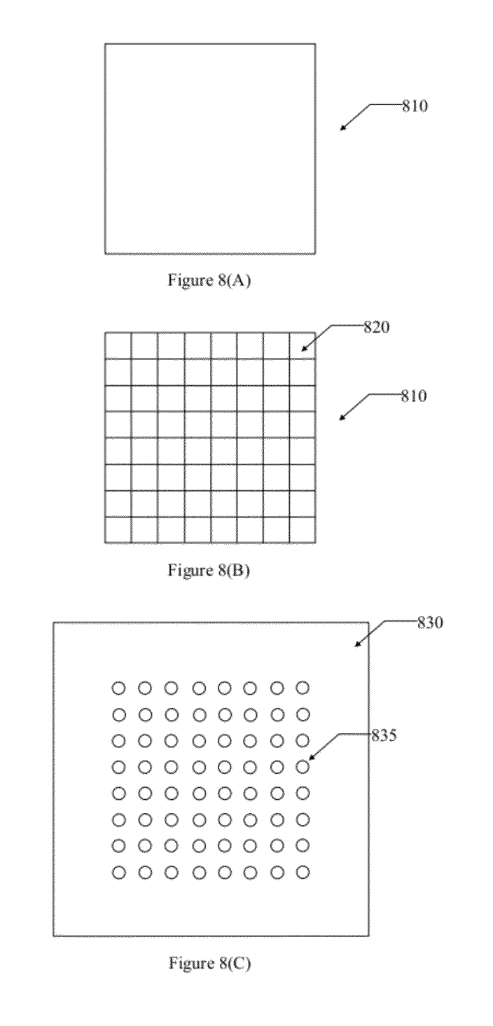

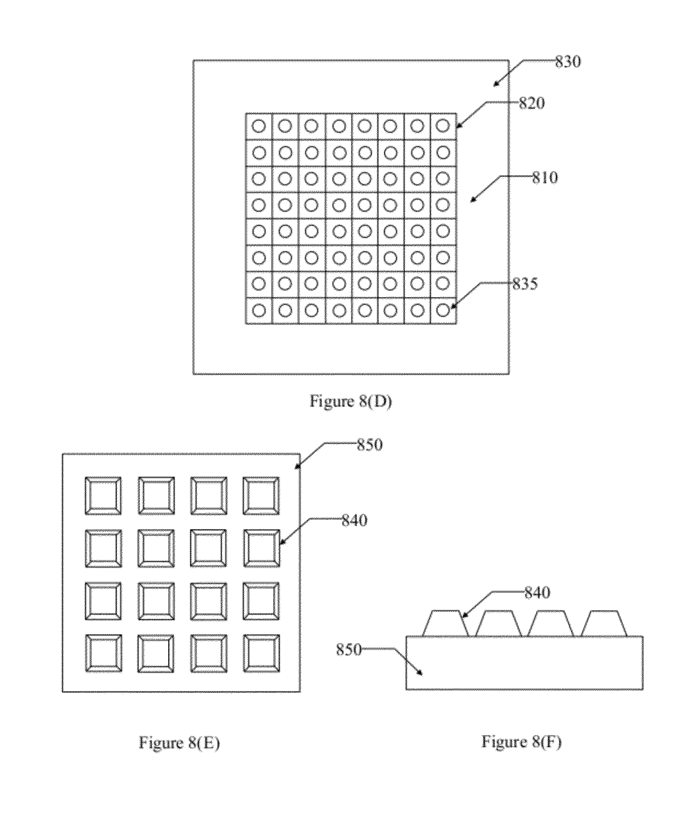

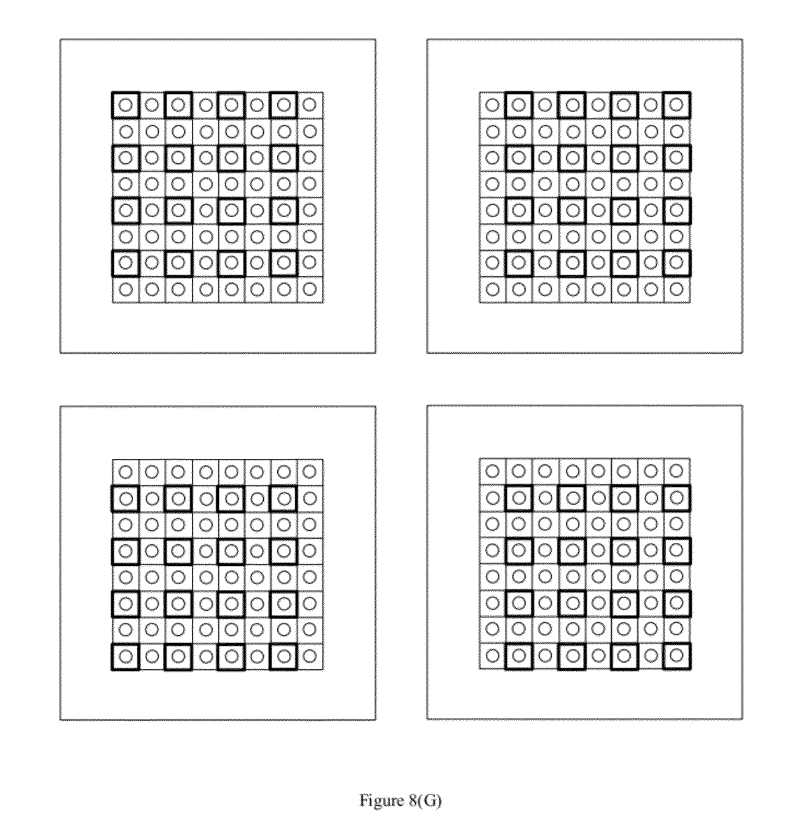

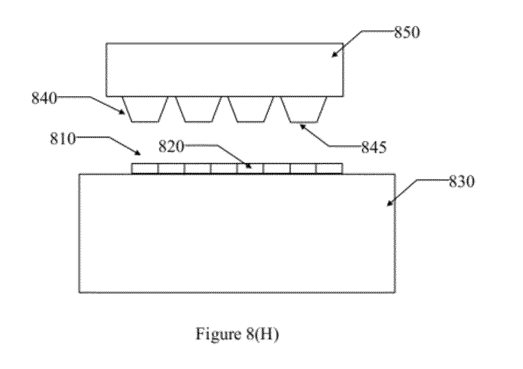

A non-limiting example of such embodiments is the simultaneously attachment of 96 substrates 110 to 96 supports 120 of a single secondary support 130 as illustrated within FIGS. 8(A)-8(H). FIG. 8(A) depicts a wafer 810, from which substrates 110 are diced. Wafer 810, for example, may be a fused silica wafer or any other suitable material or combination of materials from which substrates 110 are created, including but not limited to the previously recited non-limiting examples of material(s) for substrate 110. Within embodiments directed to the creation of arrays of biological polymers on a surface of substrate 110 (e.g., creation of arrays of different oligonucleotides on substrate 110), such array creation may occur, for example, on wafer 810 before additional processing and attachment steps are performed. The array creation may proceed according to any technique known in the art, including but not limited to those discussed within U.S. Pat. No. 5,959,098 to Goldberg et al, which is hereby incorporated by reference in its entirety for all purposes.

FIG. 8(B) depicts wafer 810 after appropriate dicing to create the individual substrates 820. In this particular illustration, 64 substrates 820 have been diced from wafer 810, but it should be evident to one of skill in the art that the quantity of substrates 820 produced from wafer 810 will depend on a variety of factors, such as the dimensions of each particular substrate 820, if each substrate 820 will possess the same dimensions, the dimensions of wafer 810, the characteristics and abilities of the technique employed to dice wafer 810, and many other factors known in the art. Any suitable technique known in the art for dicing may be employed, including but not limited to thermal laser separation, mechanical sawing, ablating lasers, laser micro jets, and stealth dicing. Many embodiments will employ a suitable means for maintaining the positioning of the substrates 820 both during and after the dicing of wafer 810. This may occur through any suitable technique, including the use of dicing tape made of polyvinyl chloride (PVC), polyolefin, polyethylene or any other suitable material(s). Alternative techniques may also be employed to obtain the net result of a wafer 810 that has been diced into substrates 820, but with the substrates 820 retaining their original position within the wafer 810. This result is important to subsequent use of the substrates 820 with many embodiments, including those where a plurality of the substrates 820 will be simultaneously attached to a plurality of supports 120.

FIG. 8(C) depicts a vacuum table 830, which contains a plurality of vacuum holes 835, from a top-down perspective while FIG. 8(D) depicts vacuum table 830 with wafer 810 placed on top of vacuum holes 835 such that each substrate 820 is positioned above a vacuum hole 835. Alternative embodiments may dice wafer 810 after proper positioning on and activation of vacuum table 830, with the optional use of, for example, wafer ring frames, to help ensure a stationary position for wafer 810 while substrates 820 are diced and that the expected positioning for substrates 820 are also maintained subsequent to dicing.

FIG. 8(E) depicts top-down view of a plurality of supports 840 which are affixed to a secondary support 850 while FIG. 8(F) depicts a horizontal view of the same. The supports 840 are depicted here as flat top pyramids, but can assume any appropriate shape. Furthermore, while 16 supports 840 are depicted here, any suitable number may be employed within other embodiments. Additionally, supports 840 may be manufactured separately from secondary support 850 and subsequently attached, or supports 840 and secondary support 850 may be a single piece (e.g., a single thermoplastic component made via injection molding which forms both supports 840 and secondary support 850). Within the particular example illustrated here, secondary support 850 possesses 16 supports 840 within rows and columns at an equal pitch. With wafer 810 possessing 64 supports 840 within 8 rows and 8 columns, this facilitates the joining of 4 complete sets of 16 substrates 820 to 4 secondary supports 850. The selection of these 4 complete sets of 16 substrates for joining with the secondary support 850 depicted within FIGS. 8(E)-8(F) is illustrated within FIG. 8(G). Specifically, the substrates 820 which possess a thick border comprise the substrates 820 which would be joined to one of the secondary supports 850 within a particular set. As is illustrated, such a selection method not only allows the attachment of substrates 820 to supports 840 simultaneously, but also completely depletes wafer 810 of all substrates 820 so that none are wasted. This basic principle can be expanded as may be desired based upon the format of a particular secondary support 850 and the number and configuration of wafer 810 and substrates 820.

For example, an assay may desire the use of 96 arrays such that a single secondary support 850 will possess 96 substrates 820 in, for instance, a format of 8 rows and 12 columns to accommodate a 96 well microtiter plate (e.g., for fluidic processing steps involving the arrays). Thus, if the wells of the 96 well microtiter plate are positioned at a 9 mm pitch, and the substrates 820 are 1.5 mm by 1.5 mm, then a wafer 810 will optimally be of a size such that it contains 3456 substrates 820. Appropriately designed and configured, this would allow 36 secondary supports 850 (each with 96 supports 840) to be attached with 96 substrates 820 while wasting no substrates 820 of the diced wafer 810.

The attachment process is depicted within FIG. 8(H). Specifically, secondary support 840 and its supports 840 are vertically and horizontally aligned with substrates 820 of wafer 810. An appropriate adhesive is then employed, for example, on either a contact surface 845 of the supports 840 and/or the top surface of the substrates 820. The secondary support 840 and vacuum table 830 are then brought together such that substrates 820 and supports 840 properly come into contact with each other within the proper alignment. Any suitable adhesive may be utilized. If an ultraviolet light curable adhesive is employed, then a vacuum table 830 which incorporates UV light sources may be easily adapted in its design and configuration by one of skill in the art to cure the adhesive. Of course, other embodiments may employ other types of adhesives, such as non-reactive adhesives (e.g., drying, pressure sensitive, contact or hot adhesives) or reactive adhesives (e.g., multi-component, heat cured, or moisture cured adhesives), natural adhesives, or synthetic adhesives. The selection of an appropriate adhesive will depend on, for example, the properties and characteristics of the materials involved (e.g., the material(s) employed for substrate 820 and support 840), the desired characteristics of manufacturing (e.g., the desired duration of the manufacturing process and how quickly the adhesive needs to permanently or semi-permanently bond the materials), the conditions in which the adhesive must subsequently endure during use of the product, and many other factors known in the art. Once the appropriate substrates 820 are affixed to the proper supports 840 of secondary support 850, the vacuum table 830 then removes the vacuum exerted through the vacuum holes 835 relevant to the affixed substrates 820. This selective removal, which ensures that the remaining substrates 820 of wafer 810 remain in their desired position through the continued exertion of vacuum, may be performed by any effective means given the particular design and configuration of the vacuum table 830 at issue (e.g., through the use of one or more gaskets). If necessary, plugs may be inserted into the vacuum holes 835 now without a substrate 820 above them. This process is then repeated as necessary to create additional secondary supports 850 which possess substrates 820 affixed to their supports 840.

### III. Examples

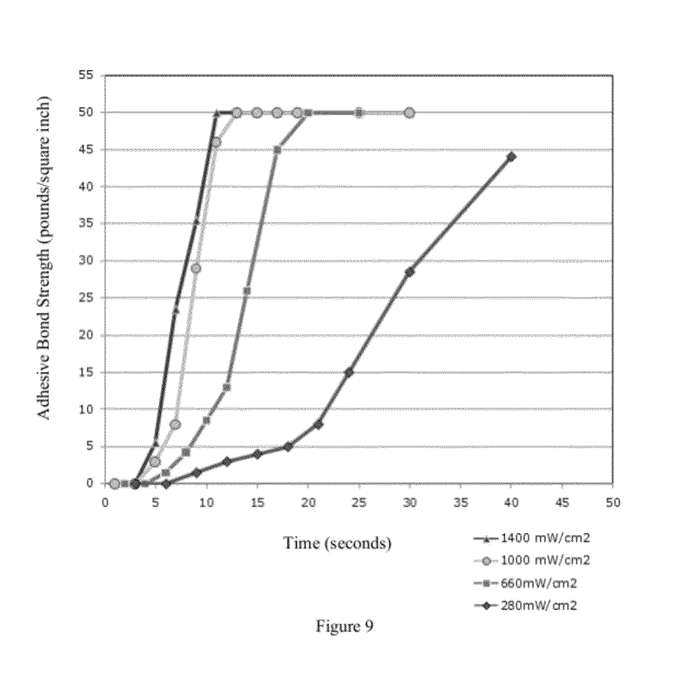

The pick-and-place curing mechanism illustrated within FIGS. 4(A)-4(B) was employed to pick-and-place and then cure a microarray (substrate 110) onto a peg (support 120) of a microarray strip (secondary support 130). UV curable adhesive was dispensed onto a surface of the peg. A vision system was used to read the alignment fiducials on the substrate contact component and on the probe array. The relative locations were recorded before the pick-and-place curing mechanism picked up the probe array by using vacuum and transferred the probe array on top of the surface of the peg with the dispensed adhesive while matching the fiducials of the plate with the probe array. The adhesive was cured while the probe array was position on the surface of the peg. This process was repeated, employing different intensities of an LED at 455 nm, and with different curing durations to determine the resulting effect on bond strength. FIG. 9 displays the results as a measure of bond strength, in pounds, versus time, in seconds. Additional testing was performed regarding the life cycle of the LED. 516,480 cycles of curing were simulated over 9 months, sufficient for production of 64,560 secondary supports 130, assuming 8 microarray substrates for the 8 supports 120 with a secondary support 130 as illustrated within FIG. 1(C). This equated to 2869.3 hours of LED on time with an average intensity of 1526.3 mW/cm² (with a standard deviation of 103.1 mW/cm² with n=64) and an average temperature during of 63.1° C. (with a standard deviation of 2.5° C.).

It is to be understood that the above description, including any examples provided herein, is intended to be illustrative and not restrictive. Many variations of the invention will be apparent to those of skill in the art upon reviewing the above description. The scope of the invention should be determined with reference to the appended claims, along with the full scope of equivalents to which such claims are entitled. All cited references, including patent and non-patent literature, are incorporated herein by reference in their entirety for all purposes.

1. An apparatus for attaching a substrate to a support, the apparatus comprising:
a housing, wherein the housing includes a substrate contact component, wherein the substrate contact component includes a substrate contact component opening, and wherein the substrate contact component and substrate contact component opening are configured to hold a substrate when vacuum is applied through the substrate contact component opening;
a light source within the housing, wherein the light source is configured to provide illumination through the substrate contact component opening; and
an attachment component, wherein the attachment component is configured to connect the apparatus to a vacuum source.

2. The apparatus of claim 1, additionally comprising:
a heat sink.

3. The apparatus of claim 2, additionally comprising:
one or more insulation components configured to direct heat generated during operation of the apparatus toward the heat sink.

4. The apparatus of claim 3, wherein the one or more insulation components comprise a first insulation component positioned on a top surface of the heat sink and a second insulation component positioned on a bottom surface of the heat sink.

5. The apparatus of claim 1, wherein the substrate contact component includes a bottom surface, wherein the bottom surface includes one or more structural features, wherein the one or more structural features extend from the bottom surface and are configured to prevent contact between the bottom surface and a substrate.

6.-9. (canceled)

10. A system for attaching a substrate to a support, the system comprising:
a substrate;
a support, wherein a top surface of the support includes a light curable adhesive;
a vacuum source; and
an apparatus, the apparatus comprising:
a housing, wherein the housing includes a substrate contact component, wherein the substrate contact component includes a substrate contact component opening, and wherein the substrate contact component and substrate contact component opening are configured to hold a substrate when vacuum is applied from the vacuum source through the apparatus to the substrate contact component opening;
a light source within the housing, wherein the light source is configured to provide illumination through the substrate contact component opening; and
an attachment component, wherein the attachment component is configured to connect the apparatus to the vacuum source.

11. The system of claim 10, wherein the apparatus additionally comprises:
a heat sink.

12. The system of claim 11, wherein the apparatus additionally comprises:
one or more insulation components configured to direct heat generated during operation of the apparatus toward the heat sink.

13. The system of claim 12, wherein the one or more insulation components comprise a first insulation component positioned on a top surface of the heat sink and second insulation component positioned on a bottom surface of the heat sink.

14. The system of claim 10, wherein the substrate comprises a top surface, wherein the substrate contact component comprises a bottom surface, wherein the bottom surface of the substrate contact component comprises one or more structural features, and wherein the one or more structural features are configured such that the top surface of the substrate only contacts the one or more structural features when the substrate is held by the apparatus.

15. The system of claim 10, wherein the substrate comprises a top surface, wherein the substrate contact component comprises a bottom surface, wherein the top surface of the substrate comprises one or more structural features, wherein the bottom surface of the substrate contact component comprises one or more structural features, and wherein the one or more structural features of the substrate and the one or more structural features of the substrate contact component are configured such that only the structural features are in contact when the substrate is held by the apparatus and other areas of the top surface of the substrate and bottom surface of the substrate contact component are not in contact.

16.-19. (canceled)

20. The system of claim 10, wherein the light source is a light-emitting diode, and wherein the light-emitting diode is positioned within the apparatus such that the illumination through the substrate contact component opening is directly above the substrate and support.

21. The system of claim 10, wherein the substrate comprises one or more structural features, wherein the one or more structural features include one or more fiducial markers, and wherein the system additionally comprises:
a vision component, wherein the vision component is configured to acquire one or more images of the substrate after vacuum is applied such that the apparatus holds the substrate, wherein the vision component is additionally configured to analyze the one or more fiducial markers within the one or more images to determine a degree of rotation of the substrate with respect to the apparatus, and wherein the vision component is further configured to effect rotation of the apparatus if the degree of rotation of the substrate does not match a predetermined optimal rotation.

22.-23. (canceled)

24. A method of attaching a substrate to a support, the method comprising:
providing a substrate and a support;
coupling the substrate to an apparatus, wherein the apparatus comprises a substrate contact component, wherein the substrate contact component includes a substrate contact component opening, and wherein the substrate is coupled to the substrate contact component through a vacuum applied to the substrate through the substrate contact component opening;
dispensing an adhesive, wherein the adhesive is curable with one or more wavelengths of light;
manipulating the apparatus such that a bottom surface of the substrate contacts a top surface of the support, wherein the adhesive is dispensed such that the adhesive is positioned between the bottom surface of the substrate and the top surface of the support;
curing the adhesive with illumination from a light source within the apparatus; and
decoupling the substrate and apparatus, wherein decoupling comprises removal of the vacuum applied to the substrate through the substrate contact component opening.

25.-26. (canceled)

27. The method of claim 24, wherein a bottom surface of the substrate contact component comprises one or more structural features, wherein the one or more structural features prevent a top surface of the substrate from contacting the bottom surface of the substrate contact component except at the one or more structural features.

28. The method of claim 24, wherein a top surface of the substrate comprises one or more structural features, and wherein the one or more structural features prevent the top surface of the substrate from contacting a bottom surface of the substrate contact component except at the one or more structural features.

29. The method of claim 24, wherein a top surface of the substrate comprises one or more substrate structural features, wherein a bottom surface of the substrate contact component comprises one or more apparatus structural features, and wherein the one or more substrate structural features and the one or more apparatus structural features prevent the top surface of the substrate from contacting a bottom surface of the substrate contact component except at the one more substrate structural features and the one or more apparatus structural features.

30. The method of claim 24, wherein the substrate includes one or more structural features, and wherein the method additionally comprises:
analyzing the substrate after coupling to the apparatus, wherein analyzing comprises determining a degree of rotation for the substrate with respect to the apparatus and comparing the degree of rotation to a predetermined optimal rotation; and
rotating the apparatus such that the degree of rotation for the substrate with respect to the apparatus matches the predetermined optimal rotation if the degree of rotation is different from the predetermined optimal rotation by a threshold amount, wherein rotation occurs before the bottom surface of the substrate contacts the top surface of the support.

31. The method of claim 30, wherein the one or more structural features include one or more fiducial markers, wherein analyzing comprises acquiring one or more images of the substrate, and wherein the one or more fiducial markers are analyzed within the one or more images to determine the degree of rotation.

32.-34. (canceled)

35. The method of claim 24, wherein the light source is positioned within the apparatus such that the illumination occurs through the substrate contact component opening.

36. The method of claim 35, wherein the light source is further positioned such that only one period of illumination is required to cure the adhesive.

37. The method of claim 36, wherein the adhesive is cured before decoupling.

38. (canceled)

39. The method of claim 24, wherein the apparatus includes a heat sink, and wherein the heat sink dissipates heat generated by the light source.

40. The method of claim 39, wherein the apparatus includes one or more insulation components, and wherein the one or more insulation components direct heat generated by the light source toward the heat sink.

41. A method of simultaneously attaching a plurality of substrates to a plurality of supports, the method comprising:
providing a plurality of substrates and a plurality of supports, wherein the plurality of substrates comprises at least a first set of substrates and a second set of substrates, and wherein the plurality of supports comprises at least a first set of supports and a second set of supports;
immobilizing the plurality of substrates;
attaching the first set of substrates to the first set of supports;
releasing the first set of substrates from immobilization, wherein any remaining substrates within the plurality of substrates remain immobilized;
removing the first set of substrates attached to the first set of supports;
attaching the second set of substrates to the second set of supports;
releasing the second set of substrates from immobilization, wherein any remaining substrates within the plurality of substrates remain immobilized; and
removing the second set of substrates attached to the second set of supports.

42.-52. (canceled)
